(19) United States
(12) Patent Application Publication
(10) Pub. No.: US 2007/0108328 A1
(43) Pub. Date: May 17, 2007

(54) Signal line, fence and method for manufacturing a fence

(75) Inventor: Mathijs Theodorus Wilhelmus Van De Ven, Asten-Heusden (NL)

Correspondence Address: THE WEBB LAW FIRM, P.C., 700 KOPPERS BUILDING, 436 SEVENTH AVENUE, PITTSBURGH, PA, 15219, US

(73) Assignee: LIGHTSPEED INVENTIONS B.V., RAALTE (NL)

(21) Appl. No.: 10/574,439

(22) PCT Filed: Oct. 1, 2004
(86) PCT No.: PCT/NL04/00685

§ 371 Date: Jan. 30, 2007

(30) Foreign Application Priority Data
Oct. 6, 2003 (NL) 1024456

(51) Int. Cl. B65H 54/553; B65H 59/00; G08B 13/00

(52) U.S. Cl. 242/129.8; 242/147 R; 340/566

(57) ABSTRACT

The invention relates to a signal line comprising a conductor for electromagnetic signals, wherein the signal line is also provided with tensioning means extending substantially parallel to the signal line, wherein the conductor is positioned by the tensioning means. The invention also relates to a fence into which such a signal line is integrated. The invention further also relates to a method for manufacturing a fence provided with a signal line comprising a conductor for electromagnetic signals.

The invention relates to a signal line comprising a conductor for electromagnetic signals. The invention also relates to an assembly of a signal line and at least one pressure element engaging on the signal line. The invention further relates to a fence into which a signal line is integrated, and to a method for manufacturing such a fence.

Line sensors comprise a signal line through which a signal can be transmitted, wherein a change in the external load on the signal line (in particular through pressure) results in a change in the signal, which can be recorded by a detection system. The signal can consist of electromagnetic radiation in the visible spectrum, but signals with radiation of other wavelengths are also possible. The European patent publication EP 0 419 267 for instance describes a system in which a pulsed light signal is transmitted through an optical fibre such that changes in the signal are detected when the optical fibre is loaded externally. Very small deformations can in any case already cause a detectable change in the signal. Such small deformations are generally referred to as microbending. The line sensors can for instance be applied as traffic sensors, safety sensors in factories or as component of a burglar alarm system.

The longer the path covered by an electromagnetic signal, the weaker the signal becomes. Not only the path length, but also incomplete reflections from the walls of the signal conductor result in signal loss. In the case of greater path lengths the change in the signal due to deformations becomes smaller relative to the signal as a whole. In order to be able to make sufficient distinction, at a poorer signal-to-noise ratio, between a standard signal and a changed signal, which results for instance under the influence of pressure on the signal conductor, sensitive, relatively expensive detection means are required. The sensitivity of the line sensor is generally the economically limiting factor for the maximum length of the signal line.

The present invention has for its object to provide a signal line which provides an improved sensitivity, whereby relatively longer signal lines can be used while maintaining the same quality of signal detection.

The invention provides for this purpose a signal line comprising a conductor for electromagnetic signals, characterized in that the signal line is also provided with tensioning means extending substantially parallel to the signal line, wherein the conductor is positioned by the tensioning means. It is possible here to envisage any type of signal line suitable for throughfeed of electromagnetic radiation, for instance light. Conductors for electromagnetic radiation usually consist of materials with a relatively low tensile strength. It is desirable that the relatively great tensioning force exerted on the tensioning means is not transferred to the conductor, or only partially so. The conductor is thus only positioned by the tensioning means, but is itself not subjected to the tensile force exerted on the tensioning means. Through tensioning of the tensioning means the conductor is optimally positioned by the tensioning means for the purpose of conducting electromagnetic radiation, wherein minimal signal loss occurs, which results in a relatively improved sensitivity compared to the non-tensioned signal line. It is possible to envisage a signal line comprising a plurality of conductors and/or tensioning means. The signal line according to the invention can be given a relatively long form, with the advantage that larger areas or peripheries can be provided with a pressure-sensitive signal line. Conversely, in simple and economically advantageous manner the sensitivity can be increased over a distance that remains the same.

It is advantageous if the tensioning means are connected to anchoring means. The tensioning means can be used to tension the signal line between two or more points at which the anchoring means engage. It is possible for instance to envisage clamps, clips, screws, windings, eyes and hooks. It is advantageous if the anchoring means are connected releasably to the tensioning means. The anchoring means can hereby engage at the desired positions on the tensioning means, whereby the tensioned length can be adapted to specific conditions. Through the use of a plurality of anchoring means over the length of the signal line the tensioning forces can moreover be distributed over different engaging positions on a support structure supporting the signal line.

In a non-limitative preferred embodiment, the tensioning means enclose at least a part of the conductor. This makes possible a uniform distribution of the positioning forces exerted by the tensioning means on the conductor during tensioning. For the at least partial enclosing of the conductor it is possible to envisage tensioning means in the form of for instance parallel fibres, a cover, a sleeve, winding, a wire, a wire mesh, a woven material or combinations thereof.

It is useful if the tensioning means comprise a tensioning material which can be placed under tensile strain. This material can be rigid, semi-rigid or elastic. It is advantageous if the tensile strain on the tensioning material amounts to a minimum of 300 to 2000 N. Depending on the flexibility of the conductor, such a tensioning force is generally sufficient to position the conductor. Tensioning means can be particularly suitable if the tensioning material comprises at least one fibre material from the following group of: polyaramid fibre, polyethylene fibre, glass fibre, carbon fibre and flourocarbon fibre. Materials including such fibre materials are commercially available under brand names such as Dyneema, Kevlar, Teflar, Nomex and Spectra. It will be apparent that many other suitable tensioning materials can also be envisaged by a skilled person.

In a non-limitative preferred embodiment, the conductor comprises an optical fibre. Examples are glass fibres, plastic optical fibres and fibres in which these two types of material are mixed. The optical fibre can be coated on the outside with one or more additional material layers, among others for instance a protective layer against mechanical damage.

In another advantageous embodiment, the signal line according to the invention comprises a cover enclosing the conductor and the tensioning means. This cover can protect the conductor and the tensioning means against external influences, in particular mechanical damage, moisture and gases. The cover can also serve to camouflage the exterior of the signal line, whereby the signal line is not recognizable as such. Plastics are preferred suitable materials from which the cover can be manufactured. The cover may also consist of multiple layers of different materials.

The invention also provides an assembly of a signal line according to the invention and at least one pressure element engaging on the signal line and having a hardness greater than the hardness of the conductor. When pressure is exerted, the pressure element concentrates the pressure force at a point of engagement between pressure element and signal line. The concentration of the force on a small area results in a greater disruption of the signal carried by the conductor, whereby the disruption is easier to detect. It will be apparent that the use of pressure elements provides a greater pressure sensitivity of the signal line. The pressure elements enable the use of longer signal lines with a pressure sensitivity which, without pressure elements, would be associated with a shorter length of the signal line. The hardness of the pressure element should be greater than that of the conductor so that the conductor, when compressed, deforms under the influence of the pressure element. Pressure elements preferably have a relatively small contact surface with the signal line, and can for instance form a casing or enclosure around the signal line, although it will be apparent that many alternative pressure elements can be envisaged by a skilled person in the field.

The invention also provides a fence into which a signal line according to the invention is integrated. Such a fence can be placed for security purposes, for instance around a company premises or private property. Persons or animals passing through, or merely loading, a fence provided with a signal line in unauthorized manner, for instance by climbing over the fence or forcing entry through the fence, will be detected when the signal line is touched or destroyed. It is advantageous if the signal line supports on the fence. The signal line can hereby be placed in simple manner at a favourable position, for instance at the top of the fence where persons climbing over the fence will contact the wire. Positions on the fence can also serve as points of engagement for tensioning the tensioning means of the signal line. In a particular preferred embodiment of the invention, the signal line is incorporated in a woven material arranged in the fence. Such a woven material generally consists of metal wire optionally provided with a plastic protective layer. Because the signal line is incorporated in the fence, it is not easy for an unauthorized person to discern that the fence is provided with detection means. It is especially advantageous when the signal line is incorporated in the fence in camouflaged manner.

The present application also provides a method for manufacturing a fence provided with a signal line comprising a conductor for electromagnetic signals, characterized in that the signal line is also provided with tensioning means extending substantially parallel to the signal line, wherein the conductor is positioned by the tensioning means, comprising the following operational steps of: attaching the signal line in a fence, and tensioning the tensioning means.

The signal line can for instance be attached to support means of the fence, for instance horizontal posts placed on or in the ground. The conductor is positioned by tensioning the tensioning means such that an optimal path for the electromagnetic signal is created with a minimal signal loss. The sensitivity of the detection system of which the signal line forms part is hereby increased.

It is advantageous if the method also comprises of anchoring the tensioning means. Owing to the anchoring, the tensioning means can hold the conductor continuously in the optimal position. The tensioning means can for instance engage on the fence, but also on the source of the electromagnetic signal or the detector of the signal which is generally situated at outer ends of the signal line. A reliable construction is obtained by anchoring the tensioning means at a plurality of positions in lengthwise direction of the signal line. The anchoring means can also function as pressure point elements. When tensioned, the tensioning means are preferably placed under a minimum tensile strain of 300 to 2000 N. Such a tensile strain is generally sufficient to position a conductor in an optimal configuration.

The invention will now be described with reference to several illustrations of non-limitative preferred embodiments.

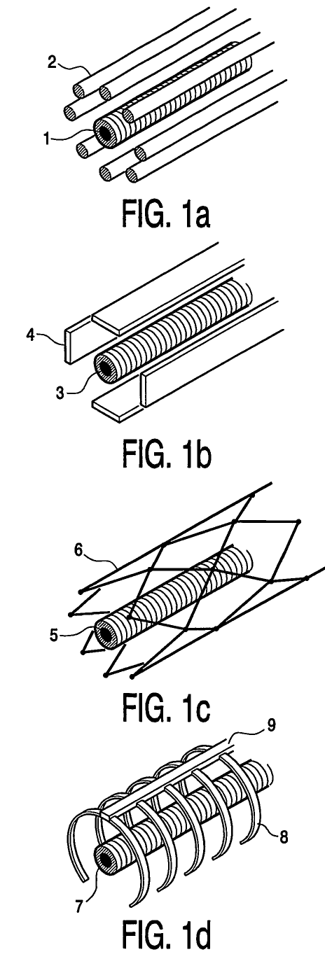

FIGS. 1a-1d show a number of perspective views of examples of signal conductors provided with tensioning means according to the present invention.

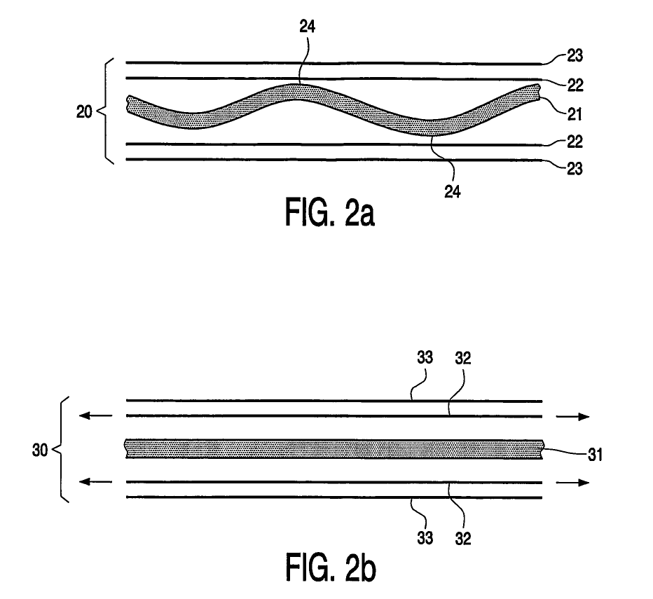

FIGS. 2a and 2b show the effect of the tensioning of tensioning means on the orientation of the conductor.

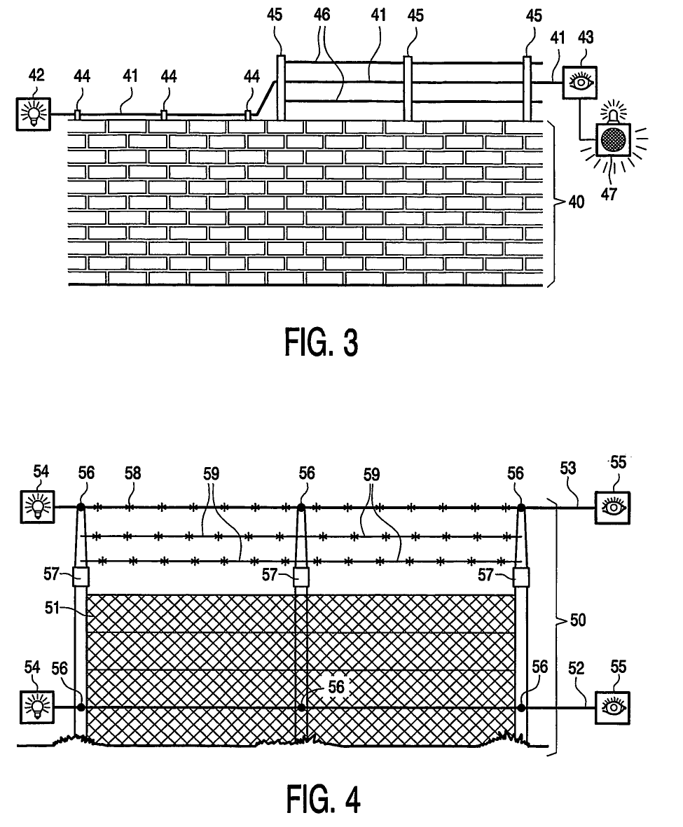

FIG. 3 shows a wall to which is attached a signal line according to the present invention.

FIG. 4 shows a fence provided with woven metal wire incorporating a plurality of signal lines according to the present invention.

In FIG. 1a a conductor 1 for electromagnetic radiation is enclosed by tensioning means in the form of tensioning wires 2. Conductor 1 makes physical contact with tensioning wires 2 and is positioned by the tensile force exerted on tensioning wires 2. For the sake of clarity the wires 2 are shown at some distance from conductor 1. In order to provide an overall picture, only a few tensioning wires 2 are drawn, but it is certainly possible to envisage using many times more wires 2 than are shown in FIG. 1a. FIG. 1b shows a conductor 3 enclosed by several tensioning strips 4. In FIG. 1c a conductor 5 is positioned by a tensioned wire mesh 6 manufactured from a strong polymer fibre material such as Dyneema. FIG. 1d shows a conductor 7 positioned by support elements 8 fixed to a tensioned cable 9.

FIG. 2a shows a longitudinal section of a signal conductor 20 comprising an optical fibre 21 enclosed by a bundle of tensioning wires 22, and a plastic outer cover 23. No tensile force is being exerted on tensioning means 22 in this figure, whereby the optical conductor 21 lies rather freely relative to cover 23. The bends and kinks 24 cause loss of signal intensity when an optical signal is transmitted through fibre 21. The deviations 24 from the ideal line of optical conductor 21 are greatly exaggerated in the figure for the sake of clarity; in reality they will generally be much smaller in relation to the length of fibre 21 than is shown in the drawing. FIG. 2b shows the effect of tensioning the tensioning wires 32 inside the outer cover 33 in lengthwise direction of signal conductor 30, whereby conductor 31 is positioned in a more ordered orientation. The orientation forced by the tensioning results in a significant reduction in signal loss compared to the situation in FIG. 2a.

FIG. 3 shows a wall 40 to which a signal line 41 according to the present invention is attached. Signal line 41 is connected to a signal source 42 which transmits a signal through signal line 41, and a detection system 43 that can record changes in the signal. On the left-hand part of wall 40 the signal line 41 is fastened to mounting brackets 44 anchored in wall 40. On the right-hand side of wall 40 the signal line 41 is tensioned between supports 45. Tensioned parallel to signal line 41 are wires 46 which have an appearance similar to that of signal line 41, whereby signal line 41 is not distinguished as such. When pressure is exerted on signal line 41, for instance by a person climbing over wall 40, this will be recorded by detection system 43, whereafter an alarm signal 47 actuated by detection system 43 is switched on.

FIG. 4 shows a fence 50 provided with a woven material of metal wires 51. Two signal lines 52, 53 according to the present invention are incorporated in the fence. Both signal lines 52,53 are connected to signal sources 54 and a detection system 55. Signal lines 52,53 are tensioned between tensioning clamps 56 arranged on posts 57 of fence 50. Signal line 52 is integrated into woven material 51, whereby a deformation of woven material 51 results in pressure on signal line 52, with the result that the signal transmitted through signal line 52 is deformed and then detected. Signal line 53 is provided with projecting parts 58, whereby signal line 53 has the appearance (and optionally also the function) of barbed wire 59 likewise incorporated in fence 50. When a person gets caught on a projecting part 58 during (unauthorized) climbing over fence 50, the projecting part 58 then functions as pressure element, whereby a disruption is recorded in the signal being transmitted through signal line 53. An attempt to destroy fence 50 is also recorded if a signal line 52,53 is broken.

1-16. (canceled)

17. A signal line comprising a conductor for electromagnetic signals, wherein the signal line is also provided with tensioning means extending substantially parallel to the signal line, wherein the conductor is positioned by the tensioning means.

18. The signal line as claimed in claim 17, wherein the tensioning means are connected to anchoring means.

19. The signal line as claimed in claim 18, wherein the anchoring means are connected releasably to the tensioning means.

20. The signal line as claimed in claim 17, wherein the tensioning means enclose at least a part of the conductor.

21. The signal line as claimed in claim 17, wherein the tensioning means comprise a tensioning material which can be placed under tensile strain.

22. The signal line as claimed in claim 21, wherein the tensile strain on the tensioning material lies at least between about 300 and 2000 N.

23. The signal line as claimed in claim 21, wherein the tensioning material comprises at least one fibre material from the following group of: polyaramid fibre, polyethylene fibre, glass fibre, carbon fibre and fluorocarbon fibre.

24. The signal line as claimed in claim 17, wherein the conductor comprises an optical fibre.

25. The signal line as claimed in claim 17, wherein the signal line comprises a cover enclosing the conductor and the tensioning means.

26. Assembly of a signal line as claimed in claim 17 and at least one pressure element engaging on the signal line and having a hardness greater than the hardness of the conductor.

27. A fence into which a signal line as claimed in claim 17 is integrated.

28. The fence as claimed in claim 27, wherein the signal line supports on the fence.

29. The fence as claimed in claim 27, wherein the signal line is incorporated in a woven material arranged in the fence.

30. A method for manufacturing a fence provided with a signal line comprising a conductor for electromagnetic signals, wherein the signal line is also provided with tensioning means extending substantially parallel to the signal line, wherein the conductor is positioned by the tensioning means, comprising the following operational steps of:
attaching the signal line in a fence, and
tensioning the tensioning means.

31. The method as claimed in claim 30, wherein the method also comprises of anchoring the tensioning means.

32. The method as claimed in claim 30, wherein when tensioned, the tensioning means are placed under a minimum tensioning force of between about 300 and 2000 N.
